(19) United States
(12) Patent Application Publication
(10) Pub. No.: US 2025/0355327 A1
(43) Pub. Date: Nov. 20, 2025

(54) MULTIFUNCTIONAL STILL PHOTOGRAPHY TABLE

(71) Applicant: Zheng Liu, Chongqing (CN)

(72) Inventor: Zheng Liu, Chongqing (CN)

(21) Appl. No.: 19/211,800

(22) Filed: May 19, 2025

(30) Foreign Application Priority Data
May 16, 2024 (CN) 2024210693496

(51) Int. Cl. G03B 15/05; G03B 15/06; G03B 17/56

(52) U.S. Cl. CPC G03B 15/05; G03B 15/06; G03B 17/561

(57) ABSTRACT

Pertaining to the technical field of photographic auxiliary equipment, the invention discloses a multifunctional still photography table comprising a frame mechanism, a load base, a background assembly and lighting assembly; the frame mechanism is combined with horizontally and vertically cross-set base frame and portal frame; the load base is formed by combining load surface set on a support bracket and load plate placed on load surface; and the background assembly comprises a component that adapts to the background of the captured object. This multifunctional still photography table addresses the following efficiency-reducing issues of the traditional still-life table when capturing white-background imagery: gray background, light pollution caused by overexposure, and unnatural reflection of products caused by the overall decrease in contrast. These issues require a lot of post-processing splicing or image matting in order to achieve the desired effect.

### TECHNICAL FIELD

The invention pertains to the technical field of photographic auxiliary equipment, specifically a multifunctional still photography table.

### BACKGROUND OF THE PRESENT INVENTION

Product still-life photography is a photographic technique that utilizes image recording equipment with a variety of lights and props to record products. Professional photographers must engage in years of study and experience to achieve professional level in photography, especially in still-life photography. Different materials and shapes also greatly influence the final result.

Highly reflective and translucent objects and wooden or plastic objects will have a very big difference in shooting. Professional photographers will adjust the lighting for different objects. This set of equipment achieves maximum integration of the shooting equipment and simplifies the shooting method, which will significantly enhances shooting efficiency while reducing technical skill requirements for photographers.

The traditional still-life table employ simple frame structure as support, utilizing an acrylic panel as the object carrier. By backlighting the acrylic panel to exceed the camera's exposure threshold, these tables attempt to create white backgrounds through overexposure. However, this still-life table usually cause: gray background, light pollution caused by overexposure, and unnatural reflection of products caused by the overall decrease in contrast, requiring a lot of post-processing splicing or image matting in order to achieve the desired effect.

### SUMMARY OF PRESENT INVENTION

In response to the deficiencies of the prior art, the present invention provides a multifunctional still photography table, which solves the problems mentioned in the above background.

The invention provides the following technical solution: a multifunctional still photography table, comprising frame mechanism, load base, background assembly and lighting assembly;
the called frame mechanism is a frame structure by combining a cross-arranged base frame and portal frame, with the portal frame installed at the middle part of the base frame. The support bracket is integrally combined and mounted on the base frame located in front of the portal frame. The transverse bracket is mounted on the portal frame;
wherein, the middle part of the transverse bracket is mounted on the portal frame through a sleeve-type adjustment fastener. Slide rails are installed on both bottom surfaces of the transverse bracket at positions in front of the portal frame, with sulphate paper II suspended on the slide rails at both sides of the transverse bracket;
the background assembly is formed by a background mechanism set up to react to the background of the object to be photographed, and the called background mechanism is set up on the bottom surface of an end of the transverse bracket located behind the portal frame;
wherein load base is formed by the combination of a placement platform set on the support bracket, and the carrier plate placed on the placement platform; the placement platform has a rotary support component inside, and the called carrier plate laps over the rotary support component; the whole carrier plate is made of round glass;
wherein the supporting frame internally arranges lifting frame, and the placement platform is mounted on the top of the lifting frame;
the called lighting assembly is a combination of photographic lamp I, photographic lamp III and photographic lamp II set around the table frame mechanism; the photographic lamp I is located directly above the load base; the photographic lamp II is set in two groups and is located on the two sides of the load base; the photographic lamp III is located at the background assembly; the photographic lamp I and the photographic lamp III are fitted with a magic arm light stand, which fitted at the bottom end with a mounting base; the called mounting base is set on the top of a portal frame, and the two sets of the photographic lamps 2 are set up on both sides of the transverse bracket through an additional bracket;
wherein a dark curtain is suspended from the bottom of the top part of the portal frame.

In a preferred embodiment of the invention, the called frame mechanism is made of metal material, and the bottom of which is mounted with support leg.

In a preferred embodiment of the invention, the support bracket mounts equidistant camera stand on its side which comprises an axial support in the shape of a portal frame as a whole. The axial support is fitted with mounting feet at both ends. The mounting feet are screwed with fixed knob sliding along the side of the support bracket, and the axial support is provided with a camera in its middle.

In a preferred embodiment of the invention, the adjuster comprises sliding sleeve sliding along the portal frame, frontally positions a fastening knob on its operative face. The fastening knob integrally carries a spindle on its rear face, the terminal portion of which screw-connects a fixed sleeve. The fixed sleeve mounts at the mid-span of the transverse bracket while monolithically integrating an edge fixing bracket along its lateral surface. The spindle threads a braking mechanism that transversely penetrates the edge fixing bracket, terminating in a fastening handle threaded at its distal end.

In a preferred embodiment of the invention, rotary support component comprises rotation control mechanism and multiple sets of load wheels, and the structures on load wheels are all rolled to the outer edge of the carrier plate.

In a preferred embodiment of the invention, the carrier wheel comprises bearing frame with the rolled edge limit wheel screwed in the middle. The outer edge of one side of the rolled edge limit wheel runs through the bearing frame and rolls against the outer edge of the carrier plate. The side of the bearing frame is screwed to a glass-load wheel by means of a mounted pivot. The carrier plate laps over the top of the glass-load wheel.

In a preferred embodiment of the invention, the rotation control mechanism adopts a driving wheel set flat as the main body, and the driving wheel of the rotation control mechanism is connected with the outer edge of the carrier plate in a rolling manner; a motor is mounted at the bottom of the rotary shaft of the rotation control mechanism, and the wheel-side stopper is set at the side of the rotation control mechanism.

In a preferred embodiment of the invention, the called rotation control mechanism comprises a drive wheel, the half shaft of which runs through and is connected with the output shaft of the motor mounted at the bottom of the placement platform, and two driven wheels are set up in the interior of the placement platform with the center point of the carrier plate as the axis, the half shafts of two of the driven wheels are vertically mounted in the interior of the placement platform, and the drive wheel and two driven wheels are sleeved with each other through the timing belt.

In a preferred embodiment of the invention, the carrier plate presents a laser cross at the center, being a combination of lasers emitted from two vertically disposed lasers. Lasers are mounted on a lifting frame and an object placing surface respectively.

In a preferred embodiment of the invention, the dark-colored fabric curtains including three groups which can be wound up separately.

In a preferred embodiment of the invention, the background mechanism comprises a flexible background panel, the top of which is suspended on the bottom of the rear end of the transverse bracket and the bottom of which is snapped on the frame mechanism. The bottom of the flexible background panel is snapped in two modes, comprising:

Mode1, the bottom of the flexible background panel may set across the carrier plate on the support bracket;

Mode2, the bottom of the flexible background panel can be snapped on the portal frame;
wherein, the called flexible background panel can be composed of different colors such as white, green and translucent according to the usage requirements;
wherein, the sulphate paper III mounts on the inside of the transverse bracket locating below the photographic lamp I at the front end of the transverse bracket.

In a preferred embodiment of the invention, the background mechanism comprises two upright posts, the top and bottom of which mounts with a lateral support and a base frame respectively. A display screen mounts on the upright posts. The sulphate paper I mounts in the interior of the transverse support, being fully covered in the inner wall of the transverse bracket.

In comparison with the prior art, the present invention has the following beneficial effects:
1. The multifunctional still photography table utilizes glass as the material for the article carrier plate. By leveraging the translucency of glass, it enables controlled exposure adjustment for background perspective, interchangeable solid-color backgrounds in various hues, and perspective mapping with image-patterned backgrounds. Furthermore, the inherent properties of glass allow capturing natural reflections during photography, eliminating the need for extensive post-processing and thereby enhancing photographic efficiency.
2. The multifunctional still photography table incorporates photographic lamps arranged at multiple angles around the carrier plate. This configuration permits independent precision lighting control for both background and foreground elements, allowing background adjustments to achieve desired effects without compromising foreground illumination. Such design satisfies professional photographers' stringent environmental requirements.
3. In this multifunctional still photography table, the circular glass carrier plate integrates motor and roller mechanisms within the platform. These components enable precise angular rotation and multiple operational modes, including intermittent 5-degree incremental rotation at any angle, continuous 360-degree rotation and electable rotation directions. Therefore, this system ensures accurate angular presentation of products during photography.

### BRIEF DESCRIPTION OF THE DRAWINGS

FIG. 1 illustrates the overall structure of the invention;

FIG. 2 illustrates the background mechanism in E.g.1 of the invention;

FIG. 3 illustrates the structure in E.g.2 of the invention;

FIG. 4 illustrates the background mechanism in E.g.2 of the invention;

FIG. 5 illustrates the structure of the equidistant camera stand;

FIG. 6 illustrates the structure of the adjuster;

FIG. 7 illustrates the structure of the placement platform;

FIG. 8 illustrates the first structural solution of rotation control mechanism in the placement platform;

FIG. 9 illustrates the second structural solution of rotation control mechanism in the placement platform;

FIG. 10 illustrates the structure of the load wheel;

FIG. 11 illustrates the structure of the dark curtain.

Reference Numerals: 1. Base frame; 2. Portal frame; 3. Support bracket; 4. Placement platform; 5. Carrier plate; 6. Equidistant camera stand; 61. Axial support; 62. Mounting feet; 63. Fixed knob; 7. Transverse bracket; 8. Adjuster; 81. Sliding sleeve; 82. Fixed sleeve; 83. Fastening knob; 84. Edge fixing bracket; 85. Braking mechanism; 86. Fastening handle; 9. Background mechanism; 91. Flexible background panel; 901. Upright post; 902. Display screen; 10. Sulphate paper I; 11. Mounting base; 12. Camera; 13. Support leg; 14. Magic Arm light stand; 15. Photographic lamp I; 16. Photographic lamp II; 17. Sulphate paper II; 18. Sulphate paper III; 19. Dark curtain; 20. Load wheel; 201. Bearing frame; 202. Limiting roller wheel; 203. Glass-load wheel; 21. Rotation control mechanism; 2101. Drive wheel; 2102. Driven wheel; 2103. Timing belt; 22. Wheel-side stopper; 23. Laser; 24. Lifting frame; 25. Photographic lamp III.

### DETAILED DESCRIPTION

The technical solutions in the embodiment of the present invention will be clearly. described below in conjunction with the accompanying drawings in the embodiment of the present invention. A complete description is given, and it is clear that the described embodiment are only a part of the embodiment of the present invention, and not all of the embodiment. Based on the embodiment in the present invention, all other embodiment obtained by a person of ordinary skill in the art without making creative labor are within the scope of protection of the present invention.

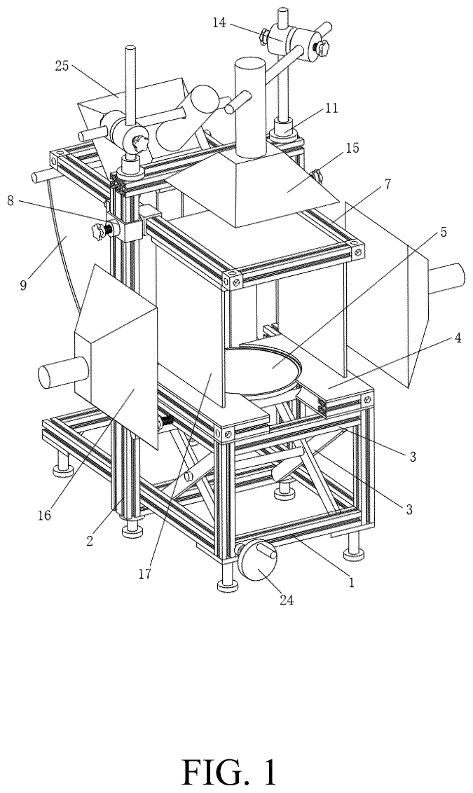

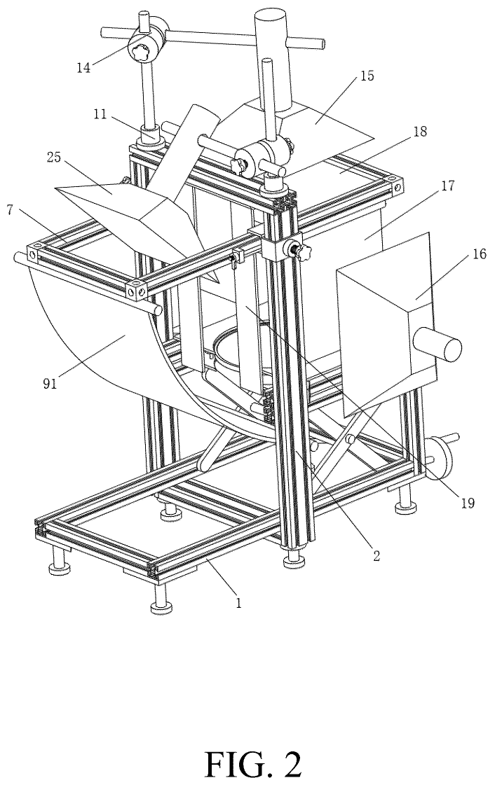

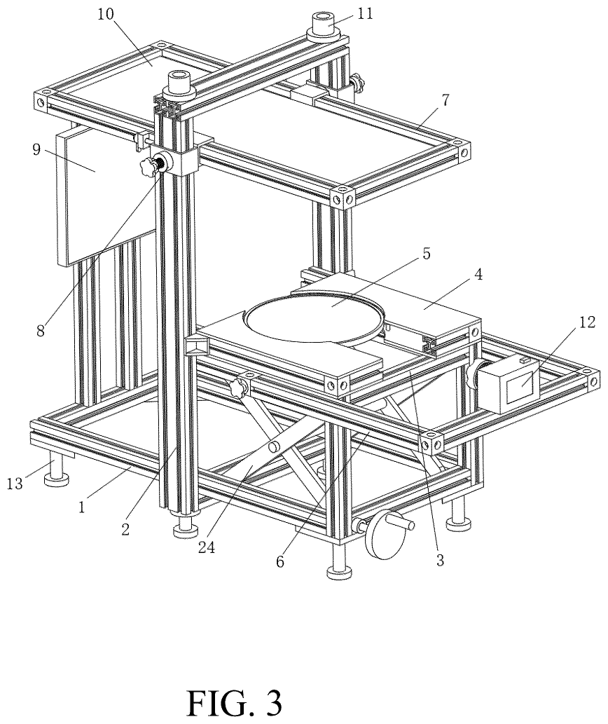

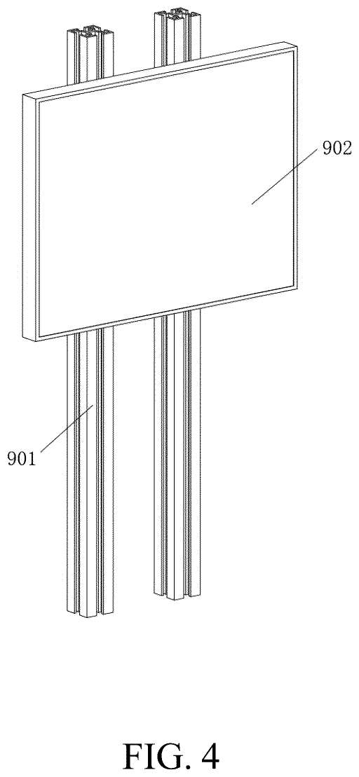

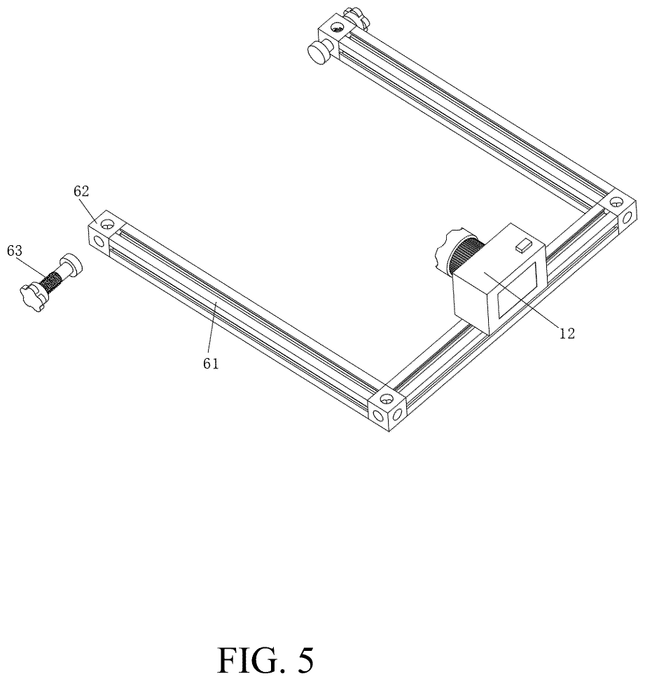

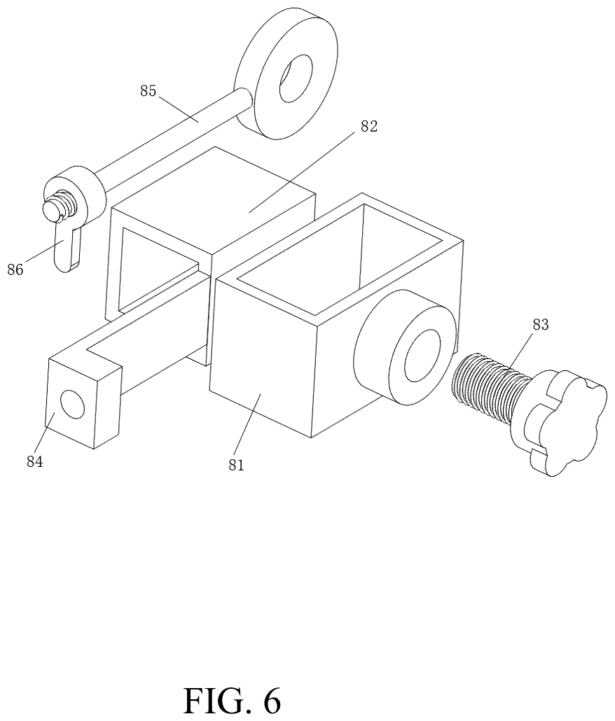

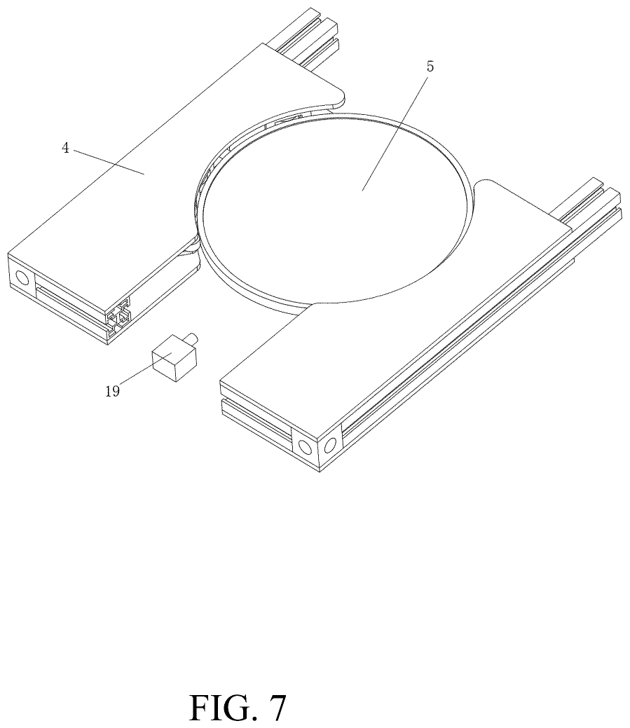

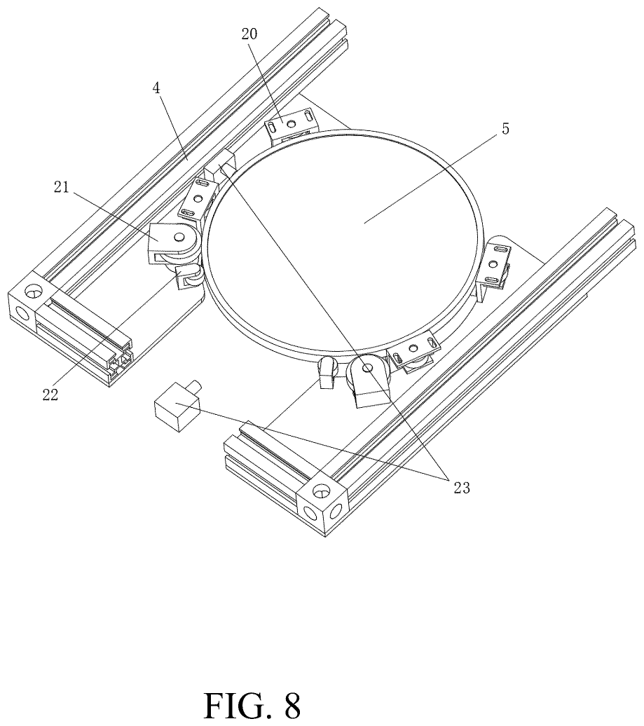

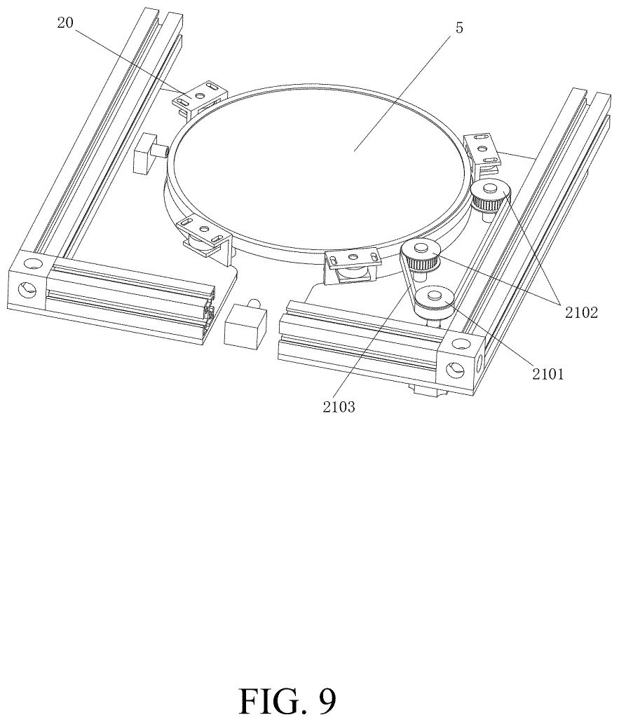

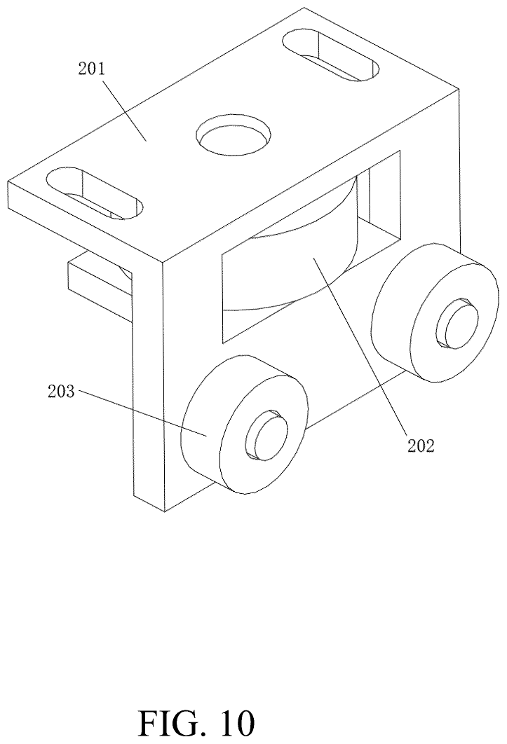

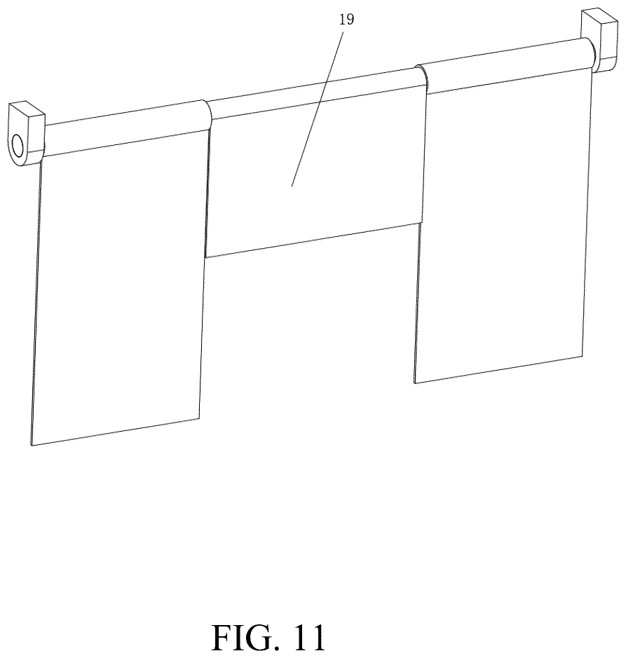

Referring to FIGS. 1-11, the multifunctional still photography table comprises: frame mechanism, load base, background assembly and lighting assembly;

The frame mechanism is a frame structure combined with a base frame 1, set horizontally and vertically crosswise, and portal frame 2. The portal frame 2 mounts in the middle of the base frame 1. The support bracket 3 integrally mounts as a unitary assembly on the base frame 1 located in front of the portal frame 2, and transverse bracket 7 is placed on the portal frame 2;

Wherein the middle part of the transverse bracket 7 is set on the portal frame 2 through a sleeve-connected adjuster 8, and the transverse bracket 7 is mounted with sliding rails on both underside portions at the front side of the portal frame 2, suspending sulphate paper II 17 from these sliding rails;

The background assembly is formed by a background mechanism 9 set up on the bottom surface of the end of the transverse bracket 7 behind the portal frame 2 to react to the background of the photographed object;

The load base is formed by the combination of a placement platform 4 set on a support bracket 3, and a carrier plate 5 is placed on the placement platform 4 which has a rotary support component inside. The called carrier plate 5 laps over the rotary support component, and the whole carrier plate 5 is made of round glass;

Wherein the supporting frame 3 internally arranges lifting frame 24, and the placement platform 4 is mounted on the top of the lifting frame 24; The lifting frame 24 is directly mounted using an eligible mechanism; and by providing the lifting frame 24 within the support frame 3, the placement platform 4 is provided with the ability to lift and adjust the height according to the photographic items required, thus finding a better photographic field of view;

The lighting assembly is a combination of photographic lamp I 15, photographic lamp III 25 and photographic lamp II 16 set around the table frame mechanism. The photographic lamp I 15 is located directly above the load base; the photographic lamp II 16 is set in two groups set on the two sides of the load base; and the photographic lamp III 25 is located at the background assembly. The photographic lamp I 15 and the photographic lamp III 25 are fitted with a magic arm light stand 14, which fitted at the bottom end with a mounting base 11. The mounting base 11 may set anywhere on the top of a portal frame 2; and the two sets of the photographic lamps II (16) are set up on both sides of the transverse bracket (7) through additional brackets; the photographic lamp II 16 may mounts at the side face and the front side. In the lighting assembly, both sets of the photographic lamp I 15 have the ability to adjust the angle of the light using the magic arm light stand 14, and the set of the photographic lamp I 15 located at the rear of the portal frame 2 is specialized in adjusting the brightness on the background assembly, so that the brightness on the background assembly is in accordance with the photographic situation; The photographic lamp III 25 can be switched between top and side positions according to the background lighting requirements.

Wherein a dark curtain 19 is suspended from the bottom of the top part of the portal frame 2.

Wherein the frame mechanism can be made of metal material and the bottom of which is mounted with support leg 13. The metal material used in the frame mechanism can be aluminum alloy, sheet metal and other materials. The support leg 13 can be made according to user requirements, universal wheels and hoof feet for two kinds of, so that the static table may easy to move or stable standing according to different situations, providing more choice for the user.

Wherein the support bracket 3 mounts equidistant camera stand 6 on its side comprises an axial support 61 in the shape of a portal frame as a whole, which is fitted with mounting feet 62 at both ends; The mounting feet 62 are screwed with fixed knob 63 slides along the side of the support bracket 3, and the axial support 61 is provided with a camera 12 in the middle of the axial support 61. The shooting position of the camera 12 is fixed using the equidistant camera stand 6 to enable the camera 12 to take distant and close-up shots at a fixed position, and also to move axially with the fixed knob 63 as a base point to enable the camera 12 to take isometric rotational images of the article.

Wherein the adjuster 8 comprises a sliding sleeve 81 sliding along the portal frame 2, frontally positing a fastening knob 83 on its operative face; the fastening knob 83 integrally carries a spindle on its rear face, and the terminal portion of which screw-connects a fixed sleeve 82, the fixed sleeve 82 sleeve-mounts concentrically at the mid-span of the transverse bracket 7, while monolithically integrating an edge fixing bracket 84 along its lateral surface; the spindle threads a braking mechanism 85 that transversely penetrates the edge fixing bracket 84, terminating in a fastening handle 86 threaded at its distal end. By providing the adjuster 8, not only can its sliding ability be utilized to make the transverse bracket 7 adjustable at different heights of the portal frame 2, but also its rotating ability can be utilized to adjust the tilting of the transverse bracket 7, so as to make the projection angle projected by the transverse bracket 7 change, and to improve the effect of the display screen of the still-life table on the placed articles.

Wherein the rotary support component comprises rotation control mechanism and multiple sets of load wheels 20 and their structure are all rolled to the outer edge of the carrier plate 5. The carrier plate 5 is positioned by setting the placement platform 4, so that the carrier plate 5 can be quickly stabilized on the placement platform 4, and at the same time, the carrier plate 5 itself belongs to a removable structure, therefore, when the carrier plate 5 becomes dirty during a long period of time, the carrier plate 5 can be directly removed for cleaning.

Wherein the load wheel 20 comprises bearing frame 201, screwed in the middle with a limiting roller wheel 202, the outer edge of one side of which runs through the bearing frame 201 and rolls against the outer edge of the carrier plate 5; and the side of the bearing frame 201 is screwed to a glass-load wheel 203 through a mounted pivot; The carrier plate 5 laps over the top of the glass-load wheel 203. The load wheel 20 is utilized as a carrier mechanism to support the rotation of the carrier plate 5, so that the carrier plate 5 functions as a hook in the process of adjusting the shooting angle without affecting the rotation of the carrier plate 5.

Among them, the rotation control mechanism 21 of the rotary support component is composed of two structural solutions;

In the first structural solution: the rotation control mechanism 21 adopts a driving wheel set flat as the main body, and the driving wheel of the rotation control mechanism 21 is connected to the outer edge of the carrier plate 5 in a rolling manner, a motor is mounted at the bottom of the rotary shaft of the rotation control mechanism 21, and a wheel-side stopper 22 is set on the side of the rotation control mechanism 21, and point contact is adopted to act as a power source for the rotation of the carrier plate 5, which provides the carrier plate 5 with rotational strength while streamlining the structure of the rotation control mechanism 21, making it more durable and improving its service life.

In the second structural solution: the rotation control mechanism 21 comprises a drive wheel 2101, and a half-axis of the drive wheel 2101 runs through and connects with a motor output shaft mounted at the bottom of the placement platform 4, and two driven wheels 2102 are provided in the interior of the placement platform 4 with the center of the carrier plate 5 as the axle, a half-axis of the two driven wheels 2102 is vertically provided in the interior of the placement platform 4, and the drive wheel 2101 and the two driven wheels 2102 are are sleeved with each other through the timing belt 2103; the timing belt 2103 can be pressed tightly using the driven wheels 2102 distributed along the edge of the carrier plate 5, to ensure that the outer edge of the carrier plate 5 and the rotation control mechanism 21, as a power source, is closely connected to each other to reduce the frequency of slipping phenomenon of the carrier plate 5.

Wherein the carrier plate 5 presents a laser cross at the center, being a combination of lasers emitted from two vertically disposed lasers 23, and lasers 23 is mounted on a lifting frame 24 and placement platform 4 respectively. By installing the laser 23, a crosshatch auxiliary line can be formed on the carrier plate 5, which can be quickly and accurately placed at the center of the original plate each time the item is placed, ensuring that when the carrier plate 5 is rotated, the item will not deviate from the center of the shooting circle due to the rotation, and thus the item will always be at the center of the shooting.

Wherein the dark curtains (19) including three groups which can be wound up separately and the width and length of each group of fabrics can be adjusted according to demand. The dark curtain 19 is installed using an existing structure that meets the conditions, and the dark curtain 19 is utilized to adjust the degree of fabric winding on the dark curtain 19 according to the different conditions of the photographed items, and to block the excess light. And it can present a black edge on the reflective surface of a highly reflective or transparent object, which is conducive to distinguishing the background and the subject of the product clearly in the picture.

Embodiment Example 1, wherein the background mechanism 9 comprises a flexible background panel 91, the top of which is suspended on the bottom of the rear end of the transverse bracket 7, and the bottom of which is snapped on the frame mechanism; and the bottom of the flexible background panel is snapped in two modes, comprising:

Mode1, the bottom of the flexible background panel 91 is set across the carrier plate 5 on the support bracket 3;

Mode2, the bottom of the flexible background panel 91 is snapped on the portal frame 2;
wherein, the flexible background panel 91 can be composed of different colors such as white, green and translucent according to the usage requirements;
wherein, the sulphate paper III 18 is mounted on the inside of the transverse bracket 7, the sulphate paper III 18 locates below the photographic lamp I 15 at the front end of the transverse bracket 7. The background of the photographed article is set using the flexible background panel 91, wherein the flexible background panel 91 may use white, green and translucent and other solid or colored backgrounds. Depending on the shooting requirements, the flexible background panel 91 can be mounted on the portal frame 2 to set the background only at the rear of the article, or mounted on the support frame 3 so that the flexible background panel 91 can span under the carrier plate 5, and utilize the transparency of the carrier plate 5 so that the bottom of the article also has a set background.

Embodiment Example 2, wherein the background mechanism 9 comprises two upright posts 901, the top and bottom of which mounts with a lateral support 7 and a base frame 1 respectively; and the display screen 902 mounts on the the upright posts 901; the sulphate paper I 10 mounts in the interior of the the transverse support 7, being fully covered in the inner wall of the transverse bracket 7. The background of the photographed item is set by mounting the display screen 902, so that the background of the photography has the ability to flow, and then simulate the outdoor or any scene, as a background, to improve the realism of the photography.

Principle of operation: When it is necessary to use the still-life table for photography, first place the item at the center of the carrier plate 5, and then open the mechanism in the placement platform 4 according to the photographic needs to control the rotation of the carrier plate 5, and mount the camera 12 on the isometric shooting frame 6 to adjust the angle of the photography, and at the same time, it has the ability to rotate the photography of the isometric axis.

When it is necessary to add a different background to set off the photographic item, the position and rotation angle of the transverse bracket 7 is adjusted using the adjuster 8, so that the background mechanism 9 is mounted on the back end of the bottom frame 1 and the transverse bracket 7, and sulphate paper I 10 is mounted on the inside of the transverse bracket 7, so that the light thrown into the photographic perspective from the outside is dispersed, and then the camera 12 can be started;

When it is necessary to use a solid color background for photography, the position and rotation angle of the transverse bracket 7 are adjusted by using the adjuster 8, and at the same time the magic arm light stand 14 is installed in the interior of the mounting base 11, the first photographic lamp 15 is set up at the front and rear ends of the transverse bracket 7, and other brackets are provided at the side of the front end of the transverse bracket 7 to support the photographic lamp II 16, and the background mechanism 9 is subsequently suspended below the rear end of the transverse bracket 7. The sulphate paper III 18 and the sulphate paper II 17 are provided inside and below the front end of the transverse bracket 7, and the dark cloth curtain 19 is hung at the center of the top of the portal frame 2, so that the dark cloth curtain 19 blocks the excess light, and then the camera 12 is finally used to take pictures.

Although the embodiments of the present utility model have been shown and described, it can be understood by those skilled in the art that various variations, modifications, substitutions, and alterations may be made to these embodiments without departing from the principles and spirit of the present utility model. The scope of the present utility model is defined by the appended claims and their equivalents.

1. In an embodiment according to the invention a multifunctional still photography table comprises: frame mechanism, load base, background assembly and lighting assembly;
wherein the frame mechanism is a frame structure combined with a base frame (1), set horizontally and vertically crosswise, and portal frame (2) mounts in the middle of the base frame (1), and support bracket (3) is integrally mounted as a unitary assembly on the base frame (1) located in front of the portal frame (2), and transverse bracket (7) is placed on the portal frame (2);
wherein the middle part of the transverse bracket (7) is set on the portal frame (2) through a sleeve-connected adjuster (8), and the transverse bracket (7) is mounted with sliding rails on both underside portions at the front side of the portal frame (2), suspending sulphate paper II (17) from these sliding rails;
the called background assembly is formed by a background mechanism (9) set up on the bottom surface of the end of the transverse bracket (7) behind the portal frame (2) to react to the background of the photographed object;
the called load base is formed by the combination of a placement platform (4) set on the support bracket (3), and a carrier plate (5) placed on the placement platform (4), the called placement platform (4) has a rotary support component inside, and the called carrier plate (5) laps over the rotary support component, and the whole carrier plate (5) is made of round glass;
wherein the supporting frame (3) internally arranges lifting frame (24), and the placement platform (4) is mounted on the top of the lifting frame (24);
the called lighting assembly is a combination of photographic lamp I (15), photographic lamp III (25) and photographic lamp II (16) set around the frame mechanism; the photographic lamp I (15) is located directly above the load base; the photographic lamp II (16) is set in two groups on the two sides of the load base; the photographic lamp III (25) is located at the background assembly; and the photographic lamp I (15) and the photographic lamp III (25) are fitted with a magic arm light stand (14), which fitted at the bottom end with a mounting base (11); the called mounting base (11) is set on the top of the portal frame (2); and the two sets of the photographic lamps II (16) are set up on both sides of the transverse bracket (7) through additional brackets;
wherein a dark curtain (19) is suspended from the bottom of the top part of the portal frame (2).

2. In an embodiment according to claim 1, a multifunctional still photography table comprises frame mechanism which made of metal material, and the bottom of which is mounted with support leg (13).

3. In an embodiment according to claim 1, a multifunctional still photography table comprises support bracket (3) with equidistant camera stand (6) mounting on its side, and the equidistant camera stand (6) comprises axial support (61); the axial support (61) is in the shape of a portal frame as a whole which is fitted with mounting feet (62) at both ends; the called mounting feet (62) are screwed with fixed knob (63) slides along the side of the support bracket (3), and a camera (12) is set on the middle part of the axial support (61).

4. In an embodiment according to claim 1, a multifunctional still photography table comprises adjuster (8); and the adjuster (8) comprises a sliding sleeve (81) sliding along the portal frame (2), frontally positions a fastening knob (83) on its operative face; the fastening knob (83) integrally carries a spindle on its rear face, the terminal portion of which screw-connects a fixed sleeve (82);
the fixed sleeve (82) sleeve-mounts concentrically at the mid-span of the transverse bracket (7), while monolithically integrating an edge fixing bracket (84) along its lateral surface; and the spindle threads a braking mechanism (85) that transversely penetrates the edge fixing bracket (84), terminating in a fastening handle (86) threaded at its distal end.

5. In an embodiment according to claim 1, a multifunctional still photography table has rotary support component comprising rotation control mechanism (21) and multiple sets of load wheels (20), and the structure of load wheels (20) are all rolled joined to the outer edge of the carrier plate (5)

6. In an embodiment according to claim 5, a multifunctional still photography table comprises load wheel (20); the load wheel (20) comprises bearing frame (201), screwed in the middle with a limiting roller wheel (202), the outer edge of one side of which runs through the bearing frame (201) and rolls against the outer edge of the carrier plate (5); and the side of the bearing frame (201) is screwed to a glass-load wheel (203) through a mounted pivot; the carrier plate (5) laps over the top of the glass-load wheel (203).

7. In an embodiment according to claim 5, a multifunctional still photography table characterized in that the called rotation control mechanism (21) adopts a driving wheel set flat as the main body, and the driving wheel of the called rotation control mechanism (21) is joined to the outer edge of the carrier plate (5) in a rolling manner, and there is an electric motor mounted at the bottom of the rotary shaft of the called rotation control mechanism (21) with wheel-side stopper (22) set at its side.

8. In an embodiment according to claim 5, a multifunctional still photography table characterized in that the called rotation control mechanism (21) comprises a drive wheel (2101), the half shaft of which running through and connected with the output shaft of the motor mounted at the bottom of the placement platform (4), the interior of the placement platform (4) is provided with two driven wheels (2102) distributed on the axis of the center point of the carrier plate (5), and the half shafts of the two driven wheels (2102) are installed vertically on the inside of the placement platform (4), and the two driven wheels (2102) are connected with each other through a timing belt (2103).

9. In an embodiment according to claim 1, a multifunctional still photography table comprises carrier plate (5), presenting a laser cross at the center, being a combination of lasers emitted from two vertically disposed lasers (23); and the lasers (23) are mounted on a lifting frame (24) and the placement platform (4) respectively.

10. In an embodiment according to claim 1, a multifunctional still photography table comprises dark curtains (19) including three groups which can be wound up separately.

11. In an embodiment according to claim 1, a multifunctional still photography table comprises a background mechanism (9) comprising a flexible background panel (91), the top of which is suspended on the bottom of the rear end of the transverse bracket (7), and the bottom of which is snapped on the frame mechanism; and the bottom of the flexible background panel (91) is snapped in two modes, comprising:
Mode1, the bottom of the flexible background panel (91) may set across the carrier plate (5) on the support bracket (3);
Mode2, the bottom of the flexible background panel (91) is snapped on the portal frame (2);
wherein, the called flexible background panel (91) can be composed of different colors such as white, green and translucent according to the usage requirements;
wherein, sulphate paper III (18) mounts on the inside of the transverse bracket (7), the sulphate paper III (18) locates below the photographic lamp I (15) at the front end of the transverse bracket (7).

12. In an embodiment according to claim 1, a multifunctional still photography table comprises a background mechanism (9), comprising two upright posts (901), the top and bottom of which mounts with the lateral support (7) and the base frame (1) respectively; and a display screen (902) is mounted on the the upright posts (901); and a sulphate paper I (10) is mounted in the interior of the the transverse support (7), being fully covered in the inner wall of the transverse bracket (7).
